(19) United States
(12) Patent Application Publication
(10) Pub. No.: US 2020/0305236 A1
(43) Pub. Date: Sep. 24, 2020

(54) FAULT DETECTOR APPARATUS AND METHOD FOR TRACK SWITCH HEATER

(71) Applicant: Railway Equipment Company, Inc., Plymouth, MN (US)

(72) Inventors: David K. Fox, Wayzata, MN (US); John C. Unze, Minnetonka, MN (US)

(21) Appl. No.: 16/825,075

(22) Filed: Mar. 20, 2020

Related U.S. Application Data
(60) Provisional application No. 62/821,780, filed on Mar. 21, 2019.

(51) Int. Cl. H05B 3/00

(52) U.S. Cl. CPC H05B 3/0014

(57) ABSTRACT

An electric heater fault detector for a rail of a railroad track is disclosed. The detector includes a power resistor electrically connected to the rail and a voltage breakdown device connected in series with the resistor to ground. The voltage breakdown device has resistance characteristics of high resistance at low voltages and low resistance at high voltages, and is preferably a metal-oxide varistor. In the event that an electric heater case applies a high voltage from a short in the electric heater to the rail, then the voltage breakdown device conducts and the power resistor and voltage breakdown device provide a path to ground for the rail. The electric heater fault detector may further include a ground fault circuit interrupt attached to the heater, whereby the ground fault circuit interrupts the application of voltage to the heater when it detects a difference in the current to the heater.

### CROSS-REFERENCE TO RELATED APPLICATIONS

This application claims the benefit of U.S. Provisional Patent Application No. 62/821,780, filed Mar. 21, 2019, entitled, “FAULT DETECTOR APPARATUS AND METHOD FOR TRACK SWITCH HEATER.” The disclosure of this priority application is hereby incorporated by reference in its entirety into the present application.

### FIELD OF THE INVENTION

The present disclosure provides a method and apparatus for selectively grounding an electrically energized railroad track rail, maintaining the ground path as an open circuit until a predetermined voltage is applied to the rail, and disconnecting the applied voltage after grounding the rail.

### BACKGROUND

In cold and snowy climates, electric heaters are often placed along railroad track rails (hereinafter “rails” or “tracks”). In particular, the heaters are placed at or near track switches. The electric heater often takes the form of an electric tubular or blade heater (i.e., a tubular heater is of the type manufactured by Wattco under the Calrod® mark). These heaters include an electrically resistive metallic alloy in the heating portion. The resistive metallic alloy impedes the flow of current and transforms part of the energy into resistive heating, which is subsequently transferred by conduction, radiation and convection. The voltages applied to the heaters are often either 230 or 480 volts. When the heat is conducted to the rails, it helps to insure that any ice and/or snow on the rails do not impede the switch from operating in its intended manner.

From time to time, due to material fatigue, vandalism and/or other unintentional damage to the heater, the voltage applied to the electric heating element may be shorted to the heater case and, in turn, applied to the rail. As will be appreciated by those skilled in the art, rails are isolated above electrical ground due to being mounted on wooden railroad ties and insulated at their ends. Accordingly, when a large voltage is applied to the rail, the rail becomes energized without a path to ground. In the past, large power resistors have been connected between the rail and ground to insure that an inadvertently energized rail does not become a safety hazard. The power resistor may take the form of a 300 ohm resistor.

The isolated rails are also used to trigger cross-arms and warning lights at railroad crossings. In simple terms, this is performed by using a low voltage signal on one side of the track with the other parallel track grounded. When a train moves onto the tracks, the train wheels and axles act to ground the low voltage. The change in voltage is sensed and triggers the cross arms and warning lights. For this purpose, the use of the 300 ohm grounding resistor described above did not interfere with the sensing mechanism because of the low current draw.

However, more recently, the rails are being used with low voltage signals on the order of one volt for other purposes—such as determining the location of trains, initiating more complex signals, etc. Because the signal is a small one-volt signal and may include data on the signal, the leakage current to ground presented by the resistor is undesirable. In addition, the resistor may introduce noise or cause the voltage to sag below the anticipated voltage level.

Therefore, there arises a need for an apparatus and method to electrically ground the track in the event of an electric heater malfunction or other event that applies an unintentional voltage to the track and which does not interfere with various intentional uses of low voltage signals applied to the tracks.

### SUMMARY

In a rail system having a potential high voltage applied to the rail, a voltage breakdown device (VBD) is located in series with a power resistor. By including the VBD in series with the power resistor, the rail is isolated above ground and a leakage current through the resistor is avoided. The VBD is preferably selected so that it does not conduct at low signal voltages employed for other purposes on the rail, but instead conducts at higher voltages employed with electric heaters for the track or other inadvertent applications of high voltages to the rails. In a preferred embodiment, a metal-oxide varistor may be used which exhibits high resistance at low voltages and low resistance at high voltages. Using a device with these resistive characteristics, if a thermal heater shorts and the case applies the shorted voltage to the rail, then the VBD becomes conductive at the higher voltage associated with the electric heater.

In addition, when the VBD conducts, a current path to ground is established. This causes a ground fault circuit device employed with the heater to sense an imbalance in the current to and from the heater. The ground fault circuit device then trips and disconnects the power to the electric heater. This in turn eliminates the unintended large voltage from being applied to the rail.

Therefore, there is provided an electric heater fault detector for a rail of a railroad track, the heater inside a case and thermally attached to the rail, comprising: a power resistor electrically connected to the rail; and a voltage breakdown device connected in series with the resistor, the voltage breakdown device having resistance characteristics of high resistance at low voltages and low resistance at high voltages, the voltage having a first end electrically connected to the resistor and a second end connected to electrical ground, wherein if the heater case applies a high voltage from a short in the electric heater to the rail, then the voltage breakdown device conducts and the power resistor and voltage breakdown device provide a path to ground for the rail.

There is further provided the electric heater fault detector as described in the previous paragraph wherein the voltage breakdown device is a metal oxide varistor. Still further, the electric heater fault detector may include a ground fault circuit interrupt attached to the heater, the ground fault circuit interrupt detecting a difference in the current supplied to the heater.

In accordance with another aspect of the invention, there is provided an electric heater fault detector for a rail of a railroad track, the heater located inside an outer shell and thermally attached to the rail, comprising: a power resistor electrically connected to the rail; a voltage breakdown device connected in series with the resistor to ground, the voltage breakdown device having resistance characteristics of a high resistance at low voltages and low resistance at high voltages; and the fault detector having a first high resistance operative state, wherein the voltage breakdown device and power resistor do not provide a path to ground, and a second low resistance operative state, wherein the voltage breakdown device and power resistor provide a path to ground, the second low resistance operative state occurring when an electrical short from the heater is applied to the rail.

In accordance with still another aspect of the invention, there is provided a method of automatically providing a path to ground for high voltage from the rail of a railroad track, comprising: connecting a power resistor electrically to the rail; and connecting a voltage breakdown device in series with the resistor to an electrical ground, the voltage breakdown device having resistance characteristics of high resistance at low voltages and low resistance at high voltages, wherein when a high voltage is applied to the rail the voltage breakdown device conducts and the power resistor and voltage breakdown device provide a path to ground from the rail.

While the invention will be described with respect to preferred embodiment configurations, methods and specifications, it will be understood that the invention is not to be construed as limited in any manner by either such configuration, methods and/or specifications described herein. Further, while the resistance of specific power resistors and specific voltage breakdown devices will be described herein, the principles of this invention extend to a circuit or device which provides very high resistance until a voltage threshold is exceeded at which time it conducts with little resistance. These and other variations of the inventions will become apparent to those skilled in the art upon a more detailed description of the inventions.

The advantages and features which characterize the inventions are pointed out with particularity in the claims annexed hereto and forming a part hereof. For a better understanding of the inventions, however, reference should be had to the drawings which form a part hereof and to the accompanying descriptive matter, in which there is illustrated and described preferred embodiments of the inventions.

### BRIEF DESCRIPTION OF THE DRAWINGS

Referring to the drawings, wherein like numerals represent like parts throughout the several views:

FIG. 1 illustrates a section of railroad tracks with an electric heater and ground path assembly is operatively attached to the rails.

FIG. 2 schematically illustrates the various components of the present invention.

FIG. 3 illustrates steps used in connection with selectively grounding an electrically energized rail and interrupting the inadvertent voltage applied to the rail from a shorted heater.

### DETAILED DESCRIPTION

The principles of the present invention are directed to connecting a voltage breakdown device (VBD) in series with a power resistor from a railroad rail to ground. By including the VBD in series with the power resistor, the rail remains isolated above ground and a leakage current through the resistor is avoided. The VBD is preferably selected so that it does not conduct at low signal voltages employed for other purposes on the rail, but instead conducts at higher voltages employed with electric heaters for the track or other inadvertent applications of high voltages to the rails.

In a preferred embodiment, a metal-oxide varistor is used as the VBD. Varistors exhibit high resistance at low voltages and low resistance at high voltages. As will be appreciated by those of skill in the art, unlike a variable resistor where the resistance value can be manually varied between a minimum and maximum value, a varistor changes its resistance automatically with a change in voltage across the device. Accordingly, a varistor has a nonlinear ohmic characteristic similar to a diode. Unlike a diode, however, the varistor has the same characteristic in both electrical directions. Thus, a varistor may be considered a voltage-dependant, non-linear resistor (sometimes referred to as a “VDR”).

Using a VBD with the resistive characteristics of a varistor, if a thermal heater shorts and the case applies the shorted voltage to the rail, then the varistor automatically becomes conductive at the higher voltage (e.g., the voltage associated with the electric heater) and a ground path is established. In addition, when the current path to ground is established, a ground fault circuit device employed with the heater senses the imbalance in the current to and from the heater. The ground fault circuit device then trips and disconnects the power to the electric heater. This in turn eliminates the unintended large voltage from being applied to the rail.

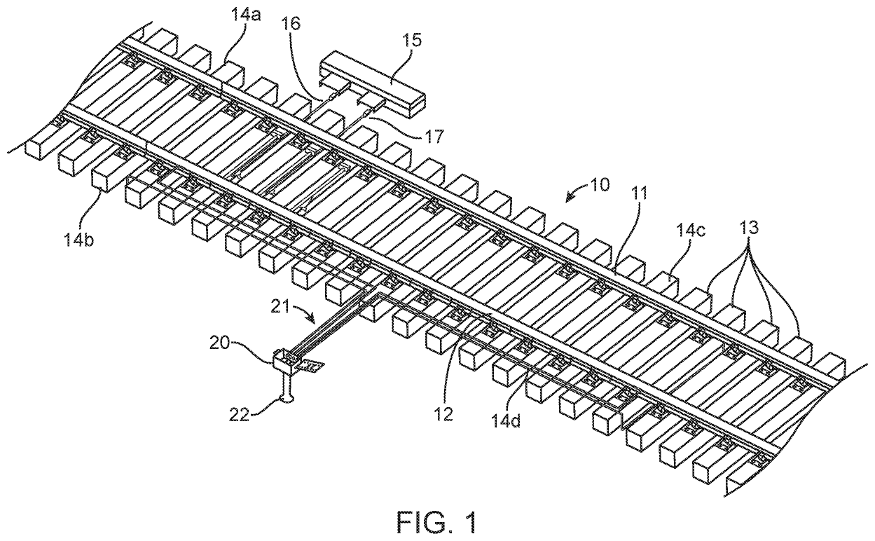

Turning now to FIG. 1, a section of railroad tracks is shown generally at 10. The two parallel rails are designated at 11 and 12. The rails 11, 12 are mounted transversely on a plurality of wooden railroad ties 13—in a manner commonly understood by those of skill in the art. The rails 11, 12 are insulated from adjacent, longitudinal rails (i.e., at locations 14a, 14b, 14c, and 14d). The mounting of the rails 11, 12 upon railroad ties 13 and insulating the rails 11, 12 from adjacent, longitudinal rails electrically isolates the rails 11, 12 and provides a structure on which low voltage signals and systems may be employed (not shown).

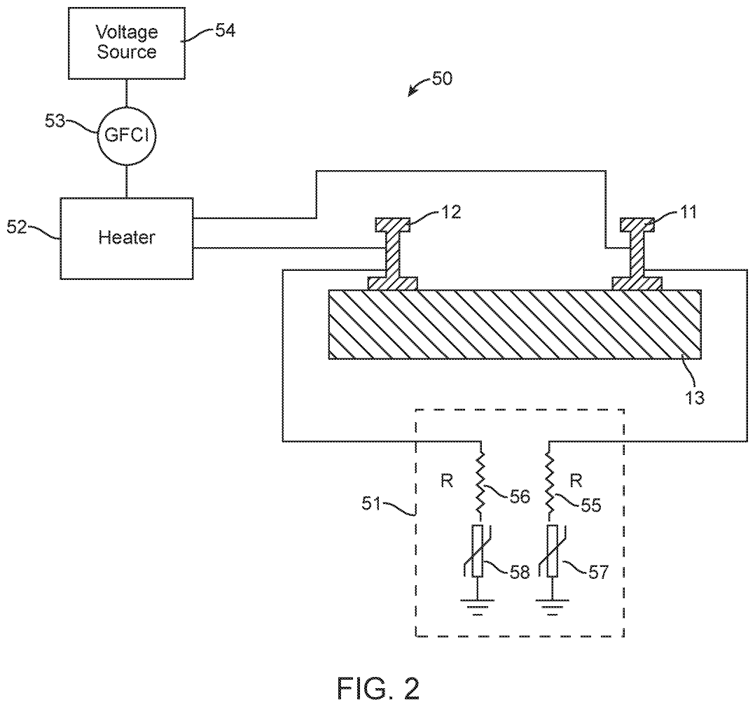

Still referring to FIG. 1, heater enclosure 15 includes a heater 52 enclosed therein (heater 52 is best seen in FIG. 2 described below). The heater 52 is thermally connected to thermal conductive connections 16 and 17 operatively connected to the rails 11, 12. Ground path circuit enclosure 20 includes ground path circuit 51 enclosed therein (ground path circuit 51 is best seen in FIG. 2 described below). The ground path circuit 51 is electrically attached to the rails by conductors 21 and is grounded at designation 22.

Turning now to FIG. 2, an embodiment constructed in accordance the principles of the present invention is schematically illustrated. The rails 11, 12 are shown mounted on railroad tie 13 in cross section.

Electric heater 52 is thermally connected to rails 11, 12 with bolts or clips (not shown). As noted above, one example of an electric heater 52 is an electric tubular or blade heater. Such heaters are available, for example, from Railway Equipment Company of Medina, Minnesota under the model designation 922 Switch Heater. These heaters include an electrically resistive metallic alloy in the heating portion. The resistive metallic alloy impedes the flow of current and transforms part of the energy into resistive heating, which is subsequently transferred by conduction to the rails 11, 12. In operation, when heat is conducted to the rails 11, 12 the heat helps insure that ice and/or snow on the rails 11, 12 does not impede the switch (not shown) from operating in its intended manner.

Voltage source 54 provides power to the heater 52. The voltages applied to these types of heaters are typically either 230 or 480 volts. A ground fault circuit interrupter 53 is used to detect a ground fault condition of the heater 52 and is arranged and configured to disconnect the voltage source 54 from the heater 52.

Ground path circuit 51 is electrically connected to rails 11, 12. Circuit 51 is thereby interposed between the rails 11, 12 and ground (electrical). The circuit 51 includes resistors 55, 56 which are sized and selected to handle the voltage and current generated from the possible inadvertent application of the voltage supplied to heater 52 to electrical ground. The resistors may have a range of 200-1000 ohms, and more preferably are 300 ohms.

Connected in series with resistors 55, 56 are voltage breakdown devices (“VBD”) 57, 58, respectively. In the preferred embodiment, the VBDs are metal oxide varistors. The varistor should be sized and selected based on the ability to handle the voltage and current generated from the possible inadvertent application of the voltage supplied to heater 52 to electrical ground. In one preferred embodiment, the varistor breaks down when 10 volts is applied to the varistor.

It will be appreciated by those of skill in the art that other breakdown voltages and other voltage breakdown devices might also be employed. For example, the breakdown voltage may be selected based on the voltage provided by voltage supply 54 or may be based on a multiple of the low voltage being used for signaling purposes on the rails 11, 12. In an embodiment, the varistors 57, 58 may breakdown at voltages greater than or equal to 30 volts. In other embodiments, the varistors may breakdown at voltages greater than or equal to 10 volts. In addition, diodes, computer controlled variable resistors and/or varactors may be configured as the VBD to operate in a low voltage/high resistance and high voltage/low resistance mode.

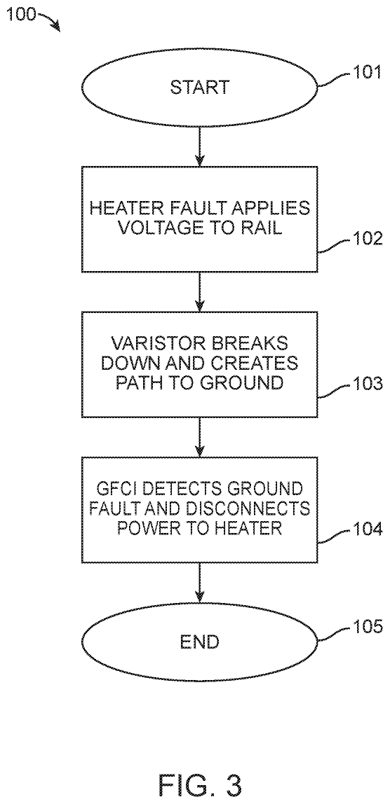

Turning now to FIG. 3 there is illustrated the method steps 100 employed by the present invention. The process begins at 101 and moves to block 102 where a voltage (i.e., caused by an electrical fault in heater 52) is applied to a rail(s) 11, 12. The rail 11, 12 becomes energized at a high voltage level—such as at the voltage first applied to the heater 52 by the voltage source 54. As described above, the rail 11, 12 is electrically isolated due to being mounted on railroad ties 13 and being insulated from adjacent, longitudinal rails at points 14a, 14b, 14c, and 14d.

At block 103, the elevated voltage is applied to ground path circuit 51 (i.e., and to at least one of varistors 57, 58). The elevated voltage provides the VBD to breakdown and provide a path to electrical ground from the rail(s) 11, 12.

At block 104, the ground fault circuit interrupter 53 detects the ground fault created by the breakdown of the ground path circuit 51 and interrupts the power from the voltage source 54 to the heater 52. This removes the inadvertent voltage from the rail 11, 12. The ground path circuit 51 is then able to return to a low voltage/high resistance state. The rails 11, 12 are thereby returned to an isolated condition for low voltage signaling and the process ends at block 105.

It should be understood that even though numerous characteristics and advantages of the present invention have been set forth in the foregoing description, together with details of the structure and function of the invention, the disclosure is illustrative only and changes may be made in detail, especially in matters of the supporting hardware, components and devices, and to the full extent indicated by the broad general meaning of the terms in which the appended claims are expressed.

What is claimed is:

1. An electric heater fault detector for a rail of a railroad track, the heater inside a case and thermally attached to the rail, comprising:
a. a power resistor electrically connected to the rail; and
b. a voltage breakdown device connected in series with the resistor, the voltage breakdown device having resistance characteristics of high resistance at low voltages and low resistance at high voltages, the voltage breakdown device having a first end electrically connected to the resistor and a second end connected to electrical ground, wherein when the heater case applies a high voltage from a short in the electric heater to the rail, then the voltage breakdown device conducts and the power resistor and voltage breakdown device provide a path to ground from the rail.

2. The fault detector of claim 1, wherein the voltage breakdown device is a metal oxide varistor.

3. The fault detector of claim 1, wherein the voltage breakdown device is selected to breakdown when a voltage of greater than or equal to ten (10) volts is applied to the device.

4. The heater fault detector of claim 1, wherein the voltage at which the voltage breakdown device characteristic changes to low resistance is less than 10% of the voltage applied to the heater.

5. The heater fault detector of claim 1, further including a ground fault circuit interrupt attached to the heater, the ground fault circuit interrupt detecting a difference in the current supplied to the heater and shutting off voltage to the heater when a ground fault is detected.

6. An electric heater fault detector for a rail of a railroad track, the heater located inside an outer shell and thermally attached to the rail, comprising:
a. a power resistor electrically connected to the rail;
b. a voltage breakdown device connected in series with the resistor to ground, the voltage breakdown device having resistance characteristics of a high resistance at low voltages and low resistance at high voltages; and
c. the fault detector having a first high resistance operative state, wherein the voltage breakdown device and power resistor do not provide a path to ground, and a second low resistance operative state, wherein the voltage breakdown device and power resistor provide a path to ground, the second low resistance operative state occurring when an electrical short from the heater is applied to the rail.

7. The fault detector of claim 6, wherein the voltage breakdown device is a metal oxide varistor.

8. A method of automatically providing a path to ground for high voltage from the rail of a railroad track, comprising:
a. connecting a power resistor electrically to the rail; and
b. connecting a voltage breakdown device in series with the resistor to an electrical ground, the voltage breakdown device having resistance characteristics of high resistance at low voltages and low resistance at high voltages, wherein when a high voltage is applied to the rail the voltage breakdown device conducts and the power resistor and voltage breakdown device provide a path to ground from the rail.

9. The method of claim 8, wherein the voltage breakdown device is a metal oxide varistor.

10. The method of claim 8, wherein the high voltage is applied to the rail from an electrical short from a heater thermally attached to the rail.

11. The method of claim 9, wherein the high voltage is applied to the rail from an electrical short from a heater thermally attached to the rail.

12. The method of claim 11, further including connecting a ground fault circuit interrupt attached to the heater, the ground fault circuit interrupt detecting a difference in the current supplied to the heater and shutting off voltage to the heater when a ground fault is detected.

13. The method of claim 8, wherein the voltage breakdown device is selected to breakdown when a voltage of greater than or equal to ten (10) volts is applied to the device.

14. The method of 11, wherein the voltage at which the voltage breakdown device characteristic changes to low resistance is less than 10% of the voltage applied to the heater.
